(19) United States
(12) Patent Application Publication
(10) Pub. No.: US 2023/0401908 A1
(43) Pub. Date: Dec. 14, 2023

(54) SYSTEM AND METHOD FOR CENTRALIZED CONTROL OF VEHICLE TESTING

(71) Applicant: Johnny Bohmer Proving Grounds, LLC, West Palm Beach, FL (US)

(72) Inventor: John Bohmer, West Palm Beach, FL (US)

(21) Appl. No.: 18/449,683

(22) Filed: Aug. 14, 2023

Related U.S. Application Data
(63) Continuation of application No. 17/836,317, filed on Jun. 9, 2022.
(60) Provisional application No. 63/208,688, filed on Jun. 9, 2021.

(51) Int. Cl. G07C 5/02; G01M 17/007

(52) U.S. Cl. CPC G07C 5/02; G01M 17/007

(57) ABSTRACT

The invention is a system and method for providing vehicle testing for various performance and efficiency criteria in a controlled manner. The system includes a computer which utilizes inputs regarding the required testing to be completed to provide a testing facility and schedule a test including personnel, safety and other parameters required for completion of the test.

### PRIORITY CLAIM

In accordance with 37 C.F.R. 1.76, a claim of priority is included in an Application Data Sheet filed concurrently herewith. Accordingly, the present invention claims priority as a continuation application to U.S. patent application Ser. No. 17/836,317, entitled “SYSTEM AND METHOD FOR CENTRALIZED CONTROL OF VEHICLE TESTING”, filed Jun. 9, 2022, which claims priority to U.S. Provisional Patent Application No. 63/208,688, entitled “SYSTEM AND METHOD FOR CENTRALIZED CONTROL OF VEHICLE TESTING”, filed Jun. 9, 2021. The contents of the above referenced applications are incorporated herein by reference in their entirety.

### FIELD OF THE INVENTION

The present invention relates to a system and method for testing motorized and alternatively propelled vehicles, including such as cars, trucks, semi tractors and trailers, heavy equipment, utility vehicles, motorcycles, high performance vehicles, high powered vehicles and other forms of ground based vehicles under controlled conditions.

### BACKGROUND OF THE INVENTION

The testing of motorized vehicles, such as cars and trucks, is well known in the art. Some testing is done with computer modeling, some is done in a lab environment such as a wind tunnel, and some is done by actually driving the vehicle on a test track or the like. Such testing can include aerodynamics; steering, for example over steering and under steering; and braking and acceleration, for example time required to achieve a given speed and speed achieved over a given distance. Such testing can evaluate performance as functions of fuel type, fuel air mixtures, type and inflation of tires, track temperature and type, aerodynamic affecting accessories, coatings on the vehicle, weight distribution, braking systems, transmission shift settings, fuel efficiency, electric vehicle range testing and efficiency, vehicle software updates, and alternative fuel/propulsion sources, such as liquid propane, hydrogen fuel cells, steam powered vehicles and so on. Testing can also include regulatory compliance testing, such as EPA and DOE testing requirements, e.g., coast down testing and safety equipment testing.

Such testing has become very sophisticated and is desirable, for all vehicles including high-performance vehicles where only slight advantages can make major differences, for example for racing. Other benefits of such testing are the ability to use both production and pre-production vehicles in a real world setting. While lab testing is desirable, for example, dynamometer testing of engines and coupled transmissions, lab testing may or may not be indicative of on the road/track performance.

It is known in this art area that the faster a vehicle travels, the more important control of vehicle parameters becomes. It is also known that even with production and pre-production vehicles of all types, the ability to control variables allows for fine adjustments to be made to vehicles to determine their effects.

### DESCRIPTION OF THE PRIOR ART

In the past, vehicle testing has been done at tracks, or test tracks, where the vehicle owner has to schedule time at such a facility and bring the needed equipment to perform the test(s). If all the equipment is not provided by the owner or owner's team, then the test will have to be delayed until the needed equipment is available at the test facility. Further, there is no third-party available to oversee safety protocols. Additionally, the owner or owner's team may not have the skills or equipment needed to conduct the test and/or analyze the test results to provide information needed to properly analyze and understand the test results.

Some of the equipment that is used in testing can be very expensive and difficult to move and set up. The absence of such equipment can compromise the value of the data collected, decreasing its value to achieve enhanced performance. Further, the test facility may not have, and is unlikely to have, a test track that is sufficiently long and straight to provide valuable aerodynamic information since most test tracks are ovals with a limited length straight section.

There is thus a need for improved systems at an improved facility for the testing of vehicles, in a controlled environment.

### SUMMARY OF THE INVENTION

Briefly, the invention is a system and method for providing vehicle testing for various performance and efficiency criteria in a controlled manner. The system includes a computer which utilizes inputs regarding the required testing to be completed to provide a testing facility and schedule a test including personnel, safety and other parameters required for completion of the test.

It is a further objective of the present invention to provide a system for testing vehicles outside of a testing lab facility on a track.

It is yet another objective of the present invention to provide such a system with facilities to improve the efficiency and accuracy of such testing.

It is a still further objective of the invention to provide such a system and method that will improve data gathering and analysis of the gathered data.

Other objects and advantages of this invention will become apparent from the following description taken in conjunction with any accompanying drawings wherein are set forth, by way of illustration and example, certain embodiments of this invention. Any drawings contained herein constitute a part of this specification, include exemplary embodiments of the present invention, and illustrate various objects and features thereof.

### BRIEF DESCRIPTION OF THE FIGURES

FIG. 1 diagrammatically illustrates a vehicle performance testing facility.

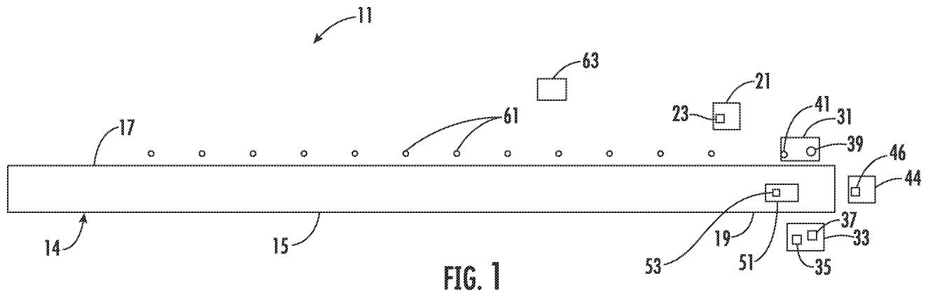

### DETAILED DESCRIPTION OF THE INVENTION

The reference numeral 11 designates, generally, a vehicle performance testing facility that has centralized control of vehicle testing. The facility 11 includes a track 14 that has a substantially straight and paved section, such as concrete and/or asphalt, designated generally 15. The track 14 has a length of at least about 2 miles, and preferably at least about 3 miles, for the substantially straight and paved section. The track 14 also includes a deceleration zone, designated generally 17; and an acceleration zone, designated generally 19. The track 11 can also include a viewing facility 21 such as a tower with an elevated viewing section that is preferably high enough to allow a viewer to see the entire length of the track 14. It is be understood that the viewing facility 21 can also be provided with sensors and/or recording devices, such as radar speed sensing guns and cameras, designated generally 23. Preferably, a camera is capable of recording what is viewed. The track 14 can be surveyed to ensure proper calibration for timing and distance measurements.

The facility 11 can be provided with one or more enclosures, e. g., buildings 31, 33. Although two buildings are shown, any suitable number can be provided. The buildings 31, 33 can be used to house test equipment, such as a dynamometer 35, a weight scale, a tire testing machine and the like. The buildings 31, 33 can also be used for storing vehicles to be tested and provide work/service areas for mechanics and the like to work on a vehicle to be tested, or that has been tested. Such a building can also be provided with a lift 37 to elevate a vehicle for inspection and/or maintenance and/or adjustments or modifications. One of the buildings 31, 33 can also be used to store fuel and the like in a tank 39. It is to be understood that one or more tanks 39 could be positioned on the exterior of a building. Such a building 31, 33 can also be used to provide one or more charging locations 41 for electrically powered vehicles. A computer facility 44 can also be provided to house suitable computer equipment 46. The computer 46 provides a centralized interface for scheduling testing, and for such things as data analysis, test needs, and parameters, along with associated safety information. The computer system 46 can also be used to receive, store and analyze information from a vehicle tester, such as a vehicle owning person or legal entity, like a corporation. Such information can include information needed to schedule a test or tests, and to provide options for testing in advance of testing. The computer 46 includes a processor, permanent and temporary memory, input devices and output devices, and the ability to connect with other computers, as is known in the art.

The computer equipment 46 can be configured for connecting to the computers of the vehicle tester(s), either through wired or wireless connections, to facilitate the transfer of data between computers, and to allow data analysis and sharing between the computers.

A vehicle 51 is brought to the facility 11 after scheduling is accomplished, as described below in any suitable manner, and can be stored in one of the buildings provided, as described above. The vehicle 51 is eventually moved to the track 14 to the acceleration zone 19. While the acceleration zone 19 and the deceleration zone 17 are shown as being fixed at opposite ends of the track 14, it is to be understood that the track 14 can be used with acceleration and deceleration in either direction, wherein the deceleration zone 17 and acceleration zone 19 can be intermittently reversed from that shown. The vehicle 51 can be provided with one or more sensors and a computer system 53 that can gather performance information, such as acceleration, deceleration, lift (front and rear), fuel consumption, horsepower and torque output, speed and the like. Markers, such as cones can be set up on the track 14 in one or more configurations, such as a FIG. 8 for multiple vehicle testing situations, such as cornering, emergency avoidance, skid pad, wet weather conditions, and the like. The gathered data can be stored in the computer system 53 and/or transmitted wirelessly in real time to the facility's computer system 46 as desired. Such data can be used to show functional relationships between the various sets of data, like horsepower output as a function of airspeed to indicate aerodynamic efficiency for different vehicle configurations. A local anemometer/weather station 63 can be provided to provide real time wind speed and direction, humidity and barometric pressure information that can be entered into the computer 46 and/or computer 53. A tester (not shown) can have a personal computer (not shown) that can also be fed the data gathered during the vehicle testing or after testing. The tester can reside in the viewing facility 21 for convenience.

Additionally, the track 14 can be provided with one or more sensors 61, such as timer components, positioned along the length of the track 14 for intermittently monitoring vehicle performance through a test run by indicating when a vehicle 51 passes a given position, i.e., travels a given distance in a measured time. Such information can be used to calculate acceleration/deceleration. Further, one of the sensors 61 can be a radar speed sensing system that can provide continuous speed and acceleration/deceleration data in real time, such as the International Mile Racing Association.

While the above describes some of the process steps in testing a vehicle on the track 14, these steps are performed during the actual performance testing of the vehicle 51. It is to be understood that prior to commencing a performance test, other information can be gathered and input into one or both of the computers 46, 53 to facilitate testing and test scheduling. The tester can access operation of the computer 46 and have the track 14 set up for requested testing, and may allow setting the sensors 61 automatically for desired operation. The tester can also ensure the desired fuel is available by using the computer 46 to designate which storage tank(s) 39 contains the desired fuel(s). Additionally, next to the storage tanks(s) 39, there are high voltage connections available which can be used in electrical vehicle applications. Such information can establish the type and degree of testing needed, facilities needed, personnel needed and the like. Listed below are examples of such information that can be gathered and provide the tester options for what they believe is needed to perform a test. The computer 46 can also provide options for the tester based on its programmed information. For example, if the anemometer 63 gives a high wind speed and/or objectionable direction, the tester can modify a proposed test run. These examples and their answers can also be used to provide the tester with recommendations to adjust their proposed test protocol to make it more efficient for a particular purpose. By way of example, the group (the tester) desiring to test the vehicle can specify in the preliminarily gathered data the type of fuel needed and whether or not the facility has the fuel or can obtain the fuel prior to testing. The group can also specify the particular type of test to be conducted; for example, tire safety testing can be provided and the testing group can be given information on the location of facilities for doing such testing, and indicate whether or not the testing group needs to bring their own equipment. The computer 46 can also be programmed to present the tester with desired tests that are possibly beneficial, and feedback information to the tester as to when there are available dates to conduct such testing. Below are some representative questions that can be provided to the tester.
1. Straight Line Aerodynamic Testing, Yes (X) No ( )
2. Straight Acceleration/G Force Test, Yes (X) No ( )
3. Straight Line Stopping Distance/G Force Test, Yes (X) No ( )
4. Timed Acceleration/MPH Over A Specified Distance, (X) 0.25 (X) 0.50 (X) 0.75 (X) 1.0 (X) 1.25 (X) 1.5 (X) 2.0 Mile (X) 2.3 Mile (X) 2.7 Mile, (X) 3 Mile.
5. Engine Mapping Over A Specified Distance, (X) 0.25 (X) 0.50 (X) 0.75 (X) 1.0 (X) 1.25 (X) 1.5 (X) 2.0 Mile (X) 2.3 Mile (X) 2.7 Mile, (X) 3 Mile.
6. Steady State & Torque Reactive Data Logging at Specified Speed, Yes (X) No ( )
7. Dynamic Engine Load Testing, (X) Yes ( ) No
8. Drive Train Failure Testing, (X) Yes ( ) No
9. Tire Safety Testing, (X) Yes ( ) No
10. Tire Wear Testing, (X) Yes ( ) No
11. Tire Performance Grip/Compound Testing, (X) Yes ( ) No
12. Reduction of Coefficient of Drag Coating Test, (X) Yes ( ) No
13. Full Acceleration to 300 KPH Back To Full Stop Test, (X) Yes ( ) No
14. Standing Mile Test, (X) Yes ( ) No
15. Top Speed Test, (X) Yes ( ) No
16. Will Your Vehicle Exceed 225 MPH (X) Yes ( ) No
17. Will You Do Emissions Testing (X) Yes ( ) No
18. Will You Do Fuel Consumption Testing (X) Yes ( ) No
19. Will You Require Calibration or Timing Equipment To Be Located On the Runway (X) Yes ( ) No
20. Will You Report Your Test Findings To appropriate Parties Such As OEM's, EPA or DOE, (X) Yes ( ) No
21. Testing Team Will Retrieve Performance Test Data from Vehicles. This Information will be Stored and Released to the Appropriate Parties Once Completed.
22. What security, if any, will the tester need?
23. Is any special equipment needed, e.g., foam fire-fighting equipment?
24. Is certification of test needed?

Additional information can be requested of a tester to provide additional options for a proposed test and be input into the computer 46.

1. Contact and location information for test facility 11 and for the tester.

2. Tester briefing schedule.

3. Radio communication system provision setup schedule.

4. End of testing activity for each day and for total test notification.

5. Emergency Plans and Communication protocol.

6. Safety protocols by tester and testing facility.

7. Fuel spill protocol and notification protocol.

8. Fueling operation plan by tester and testing facility.

9. Is a portable generator needed and what type.

10. Type of food and food service needed.

11. Collateral information needed, e.g., certificate of insurance, hold harmless.

12. Attendee identification and nationality.

13. Aerial photography needs, if any.

14. Media coverage and identification of media personnel.

15. List of available partners of testing facility and their capabilities.

16. Tester check in schedule and protocol.

The information from the tester can be input into the computer 46 for processing, and, once processing is completed, the results of the analysis for conducting the requested testing can be transferred to the tester automatically, as to available dates for testing, what facilities are available at the track 14, what the tester will need to provide, and what the facility 11 can provide. Further, the tester can request a desired level of security, and informed of what can be made available by the track facility. A proposed schedule for the testing each day can be provided to the tester, along with auxiliary help availability.

The computer 46 can also be provided with additional information; for example, fuel pricing and availability. Such information can be updated as appropriate. If queried by the tester, the computer 46 can also present such information to the tester. Such information can be made available automatically to the tester. The computer 46 can be programmed to check existing scheduling, estimate the time needed for the proposed testing, and determine when there is enough available time to conduct the proposed testing based on the answers input into the computer 46 by the tester in response to queries such as those detailed above. An estimated total testing fee for use of the facility 11 can also be provided to the tester, along with an estimated fee for each component of the total fee. The computer 46 can also be programmed to provide a sub-schedule for when each test component can be done during the scheduled test dates.

An agreement can be created between a tester and the testing facility by using an option selection method. As described above, by way of example, certain capabilities of the testing facility are presented to the tester via interconnected computers. The tester selects from the menu of options what is desired, such as those listed above. If the testing facility agrees that the options can be made available, the tester is informed of availability, price and time slot availability. If acceptable to the tester, the tester can accept and scheduling is accomplished. If a test option is not listed as available, the tester can query the testing facility 11 through the computer connection, and the testing facility 11 can respond if such service/facility can be made available and can be added to the agreement. Such arrangements may include, but should not be limited to, security, portable wind tunnels, catering, sleeping facilities and the like.

All patents and publications mentioned in this specification are indicative of the levels of those skilled in the art to which the invention pertains. All patents and publications are herein incorporated by reference to the same extent as if each individual publication was specifically and individually indicated to be incorporated by reference.

It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary, and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. A system for setting up the testing of various performance criteria of a vehicle at a testing facility comprising:
a computer including a processor, a permanent and a temporary memory, at least one input device and at least one output device, said computer constructed and arranged to connect with other computers for bi-directional communication, said computer providing a centralized interface for scheduling vehicle testing based upon selected testing parameters, the computer including information regarding facilities for vehicle testing and parameters required for completion of each vehicle test, wherein a user selects at least one testing parameter and the computer identifies secondary parameters for the at least one selected testing parameter and returns to the user a choice of facilities and dates suitable for completion of the vehicle testing, wherein the computer provides an associated test protocol for the vehicle test.

2. The system for setting up the testing of various performance criteria of a vehicle at a testing facility of claim 1 wherein the computer also provides safety information regarding the vehicle test, the safety information varying based upon the vehicle test criteria chosen by the user.

3. The system for setting up the testing of various performance criteria of a vehicle at a testing facility of claim 1 wherein the computer is programmed to check existing scheduling, estimate the time needed for the proposed testing, and determine when there is enough available time to conduct the proposed testing based upon input into the computer by the user.

4. The system for setting up the testing of various performance criteria of a vehicle at a testing facility of claim 1 wherein the computer provides an estimated total testing fee for use of each applicable facility, along with an estimated fee for each component of the total testing fee.

5. The system for setting up the testing of various performance criteria of a vehicle at a testing facility of claim 3 wherein the computer is programmed to provide a sub-schedule for when each test component can be completed during the available test dates.

6. The system for setting up the testing of various performance criteria of a vehicle at a testing facility of claim 1 wherein the computer is programmed to ensure the desired type of fuel is available at the testing facility, including electrical fuel and hydrocarbon fuels.

7. The system for setting up the testing of various performance criteria of a vehicle at a testing facility of claim 6 wherein vehicle fueling protocols are provided to the user including placement of fuel at the testing facility, safety requirements, and personnel required to be present during fueling of the vehicle.

8. The system for setting up the testing of various performance criteria of a vehicle at a testing facility of claim 1 wherein the testing parameters requiring user input into the computer to provide a facility and scheduling of a vehicle test are selected from the group consisting of:
Straight Line Aerodynamic Testing, Yes ( ) No ( ), Straight Acceleration/G Force Test, Yes ( ) No ( ), Straight Line Stopping Distance/G Force Test, Yes ( ) No ( ), Timed Acceleration/MPH Over A Specified Distance, ( ) 0.25 ( ) 0.50 ( ) 0.75 ( ) 1.0 ( ) 1.25 ( ) 1.5 ( ) 2.0 Mile ( ) 2.3 Mile ( ) 2.7 Mile, ( ) 3 Mile.

9. The system for setting up the testing of various performance criteria of a vehicle at a testing facility of claim 1 wherein the testing parameters requiring user input into the computer to provide a facility and scheduling of a vehicle test are selected from the group consisting of:
Engine Mapping Over A Specified Distance, ( ) 0.25 ( ) 0.50 ( ) 0.75 ( ) 1.0 ( ) 1.25 ( ) 1.5 ( ) 2.0 Mile ( ) 2.3 Mile ( ) 2.7 Mile, ( ) 3 Mile, Steady State & Torque Reactive Data Logging at Specified Speed, Yes ( ) No ( ), Dynamic Engine Load Testing, ( ) Yes ( ) No, Drive Train Failure Testing, ( ) Yes ( ) No.

10. The system for setting up the testing of various performance criteria of a vehicle at a testing facility of claim 1 wherein the testing parameters requiring user input into the computer to provide a facility and scheduling of a vehicle test are selected from the group consisting of:
Tire Safety Testing, ( ) Yes ( ) No, Tire Wear Testing, ( ) Yes ( ) No, Tire Performance Grip/Compound Testing, ( ) Yes ( ) No, Reduction of Coefficient of Drag Coating Test, ( ) Yes ( ) No.

11. The system for setting up the testing of various performance criteria of a vehicle at a testing facility of claim 1 wherein the testing parameters requiring user input into the computer to provide a facility and scheduling of a vehicle test are selected from the group consisting of:
Full Acceleration to 300 KPH Back To Full Stop Test, ( ) Yes ( ) No, Standing Mile Test, ( ) Yes ( ) No, Top Speed Test, ( ) Yes ( ) No, Will Vehicle Exceed 225 MPH ( ) Yes ( ) No.

12. The system for setting up the testing of various performance criteria of a vehicle at a testing facility of claim 1 wherein the testing parameters requiring user input into the computer to provide a facility and scheduling of a vehicle test are selected from the group consisting of:
Emissions Testing ( ) Yes ( ) No, Fuel Consumption Testing ( ) Yes ( ) No, Will You Require Timing Equipment ( ) Yes ( ) No, Will Test Findings be reported to appropriate parties including OEM's, EPA or DOE, ( ) Yes ( ) No.
